(19) United States
(12) Patent Application Publication
(10) Pub. No.: US 2024/0222712 A1
(43) Pub. Date: Jul. 4, 2024

(54) SMART BATTERY MODULES FOR RACK SYSTEMS

(71) Applicant: AcLeap Power Inc., Taipei City (TW)

(72) Inventors: Roy J. Davis, Rowlett, TX (US); Michael C. Williams, McKinney, TX (US); Viesna Dam, Sachse, TX (US); Minglong He, Baden (CH)

(21) Appl. No.: 18/090,739

(22) Filed: Dec. 29, 2022

(51) Int. Cl. H01M 10/42; H02J 7/00

(52) U.S. Cl. CPC H01M 10/425; H02J 7/0014; H02J 7/0048; H01M 2010/4271; H01M 2010/4278

(57) ABSTRACT

In one aspect, a removable battery module for a rack system that includes at least one rack controller is provided. The removable battery module includes at least one battery, a communication interface configured to communicatively couple with the at least one rack controller, and a module controller. The module controller is configured to estimate a state of charge (SOC) of the at least one battery at startup, determine whether at least one trigger has occurred, and start a float timer in response to determining that the at least one trigger has occurred. The module controller is further configured to generate a current estimate for the SOC by increasing the estimated SOC over a remaining time of the float timer based on a float current, and report, via the communication interface, the current estimate for the SOC to the at least one rack controller.

### BACKGROUND

The field of the disclosure relates to server/equipment racks, and more particularly, to racks that integrate smart battery modules that power the servers/equipment in the racks when electrical power supplied to the racks is lost.

Datacenters and other high-density server locations typically install their servers, switches, firewalls, etc., (referred to herein as rack-mount equipment) in rack enclosures. Rack-mount equipment typically has a standard width and a height that falls within one of the standard rack units (e.g., 1U, 2U, 3U, 4U, etc.).

High-density server locations, such as datacenters, typically utilize both short-term power backup solutions (e.g., battery installations in specialized rooms) and longer-term power backup solutions (e.g., diesel generators) to ensure that the rack-mount equipment remains powered in the event that the utility power fails. Although rack-mount uninterruptable power supplies (UPSs) can be loaded into a rack next to the rack-mount equipment, the vertical space in a rack is limited, and the addition of rack-mount UPSs in the rack reduces the density of the rack-mount equipment within the rack. Further, rack-mount UPSs include both batteries and inverters in a shared enclosure, which is duplicated for each rack-mount UPS installed in a rack and is an inefficient use of space in the rack. Thus, it would be desirable to provide additional power backup solutions that are more flexible than fixed-installation battery power backup solutions or rack-mount UPS solutions.

### BRIEF DESCRIPTION

In one aspect, a removable battery module for a rack system is provided. The rack system includes at least one rack controller. The removable battery module includes at least one battery, a communication interface configured to communicatively couple with the at least one rack controller, and a module controller. The module controller is configured to estimate a state of charge (SOC) of the at least one battery at startup, determine whether at least one trigger has occurred, and start a float timer in response to determining that the at least one trigger has occurred. The module controller is further configured to generate a current estimate for the SOC of the at least one battery by increasing the estimated SOC over a remaining time of the float timer based on a float current, and report, via the communication interface, the current estimate for the SOC of the at least one battery to the at least one rack controller.

In another aspect, a method operable by a removable battery module for a rack system is provided. The rack system includes at least one rack controller. The method includes estimating a SOC of at least one battery of the removable battery module at startup, determining whether at least one trigger has occurred, and starting a float timer in response to determining that the at least one trigger has occurred. The method further includes generating a current estimate for the SOC of the at least one battery by increasing the estimated SOC over a remaining time of the float timer based on a float current, and reporting the current estimate for the SOC of the at least one battery to the at least one rack controller.

In another aspect, a rack system is provided. The rack system includes a mounting frame, at least one rack controller, and at least one removable battery module. The mounting frame is configured to mount rack-mount equipment within an interior portion of the rack system, where the mounting frame extends along at least a portion of a height of the rack system. The at least one rack controller is disposed within a peripheral portion of the rack system, where the peripheral portion is disposed external to the interior portion and extends along at least a portion of the mounting frame. The at least one removable battery module is disposed within the peripheral portion. Each of the at least one removable battery modules includes at least one battery, a communication interface, and a module controller. The communication interface is configured to communicatively couple with the at least one rack controller. The module controller is configured to estimate a SOC of the at least one battery at startup, determine whether at least one trigger has occurred, and start a float timer in response to determining that the at least one trigger has occurred. The module controller is further configured to generate a current estimate for the SOC of the at least one battery by increasing the estimated SOC over a remaining time of the float timer based on a float current, and report, via the communication interface, the current estimate for the SOC of the at least one battery to the at least one rack controller.

### DRAWINGS

These and other features, aspects, and advantages of the present disclosure will become better understood when the following detailed description is read with reference to the accompanying drawings in which like characters represent like parts throughout the drawings, wherein:

FIG. 1 depicts a front perspective view of a rack system in an exemplary embodiment.

FIG. 2 depicts a rear perspective view of the rack system of FIG. 1 in an exemplary embodiment.

FIG. 3 depicts a front perspective view of a removable battery module for the rack system of FIG. 1 in an exemplary embodiment.

FIG. 4 depicts a block diagram of the removable battery module of FIG. 3 in an exemplary embodiment.

FIG. 5 depicts a state of charge state machine for the batteries of the removable battery module of FIG. 3 in an exemplary embodiment.

FIG. 6 depicts a flow chart of a method operable by the removable battery module of FIG. 3 in an exemplary embodiment.

Unless otherwise indicated, the drawings provided herein are meant to illustrate features of embodiments of this disclosure. These features are believed to be applicable in a wide variety of systems comprising one or more embodiments of this disclosure. As such, the drawings are not meant to include all conventional features known by those of ordinary skill in the art to be required for the practice of the embodiments disclosed herein.

### DETAILED DESCRIPTION

In the following specification and the claims, reference will be made to a number of terms, which shall be defined to have the following meanings.

The singular forms “a”, “an”, and “the” include plural references unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

As used herein, the terms “processor” and “computer,” and related terms, e.g., “processing device,” “computing device,” and “controller” are not limited to just those integrated circuits referred to in the art as a computer, but broadly refers to a microcontroller, a microcomputer, an analog computer, a programmable logic controller (PLC), an application specific integrated circuit (ASIC), and other programmable circuits, and these terms are used interchangeably herein. In the embodiments described herein, “memory” may include, but is not limited to, a computer-readable medium, such as a random-access memory (RAM), a computer-readable non-volatile medium, such as a flash memory. Alternatively, a floppy disk, a compact disc-read only memory (CD-ROM), a magneto-optical disk (MOD), and/or a digital versatile disc (DVD) may also be used. Also, in the embodiments described herein, additional input channels may be, but are not limited to, computer peripherals associated with an operator interface such as a touchscreen, a mouse, and a keyboard. Alternatively, other computer peripherals may also be used that may include, for example, but not be limited to, a scanner. Furthermore, in the example embodiment, additional output channels may include, but not be limited to, an operator interface monitor or heads-up display. Some embodiments involve the use of one or more electronic or computing devices. Such devices typically include a processor, processing device, or controller, such as a general-purpose central processing unit (CPU), a graphics processing unit (GPU), a microcontroller, a reduced instruction set computer (RISC) processor, an ASIC, a programmable logic controller (PLC), a field programmable gate array (FPGA), a digital signal processing (DSP) device, and/or any other circuit or processing device capable of executing the functions described herein. The methods described herein may be encoded as executable instructions embodied in a computer readable medium, including, without limitation, a storage device and/or a memory device. Such instructions, when executed by a processing device, cause the processing device to perform at least a portion of the methods described herein. The above examples are not intended to limit in any way the definition and/or meaning of the term processor and processing device.

As discussed previously, fixed installation battery power backup solutions (e.g., battery rooms) and/or rack-mount UPSs lack the flexibility and/or utilize valuable rack space that would normally be used for rack-mount servers, switches, etc. In the embodiments described herein, a rack system is described that includes power backup infrastructure located at the perimeter of the rack system, which frees up the interior portion of the rack system for rack-mount equipment. The rack system includes, at peripheral portions of the rack system, battery modules, power distribution units (PDUs), controllers, rectifiers, etc., which provide power backup solutions to the rack-mounted equipment loaded into the rack system. Because the power backup solutions are disposed at the peripheral portions of the rack system, the interior portion is available for rack-mount equipment and/or additional battery modules. Further in the embodiments described herein, battery modules are described for the rack system that include localized control systems that monitor the state of charge (SOC) of the batteries located within the battery modules, which enables the rack system to accurately track the state of charge of the batteries in the battery modules during high-rate discharge applications.

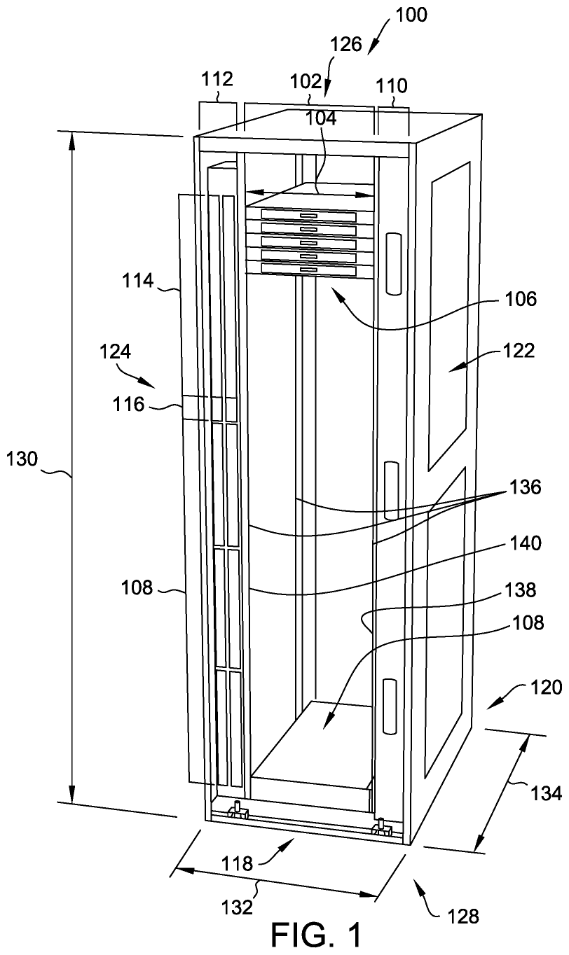

FIG. 1 is a front perspective view of a rack system 100 in an exemplary embodiment. In this embodiment, rack system 100 has an interior portion 102 which has an interior width 104 sized to accept rack-mount equipment 106 and/or removable battery modules 108. In this embodiment, rack system 100 includes a first peripheral portion 110 and a second peripheral portion 112. First peripheral portion 110 is sized and configured to accept cabling, not shown. Second peripheral portion 112 includes one or more rectifiers 114, one or more rack controllers 116, and one or more removable battery modules 108. In some embodiments, rectifiers 114 and/or rack controllers 116 are also removable from rack system 100. In some embodiments, first peripheral portion 110 includes one or more rectifiers 114, one or more rack controllers 116, and/or one or more removable battery modules 108. In other embodiments, second peripheral portion 112 is sized and configured to accept cabling, not shown, and first peripheral portion 110 includes one or more rectifiers 114, one or more rack controllers 116, and one or more removable battery modules 108.

Rectifiers 114 rectify alternating current (AC) power supplied by an AC power source (e.g., a utility (not shown)), which is used to supply power to removable battery modules 108 and/or rack-mount equipment 106, during normal operation. If the power supplied by the AC power source fails, then removable battery modules 108 temporarily provide power to rack-mount equipment 106. Rack controllers 116 communicate with removable battery modules 108 and coordinate the power backup solution for rack system 100. Removable battery modules 108, rack controllers 116, and rectifiers 114 may operate as a group to provide power backup solutions to rack-mount equipment 106 and/or may operate in redundant configurations in other embodiments to provide power backup solutions to rack-mount equipment 106.

In this embodiment, rack system 100 includes a front portion 118, a rear portion 120, a first side portion 122, a second side portion 124, a top portion 126, and a bottom portion 128. Rack system 100 has a height 130 defined by a distance between top portion 126 and bottom portion 128, an exterior width 132 defined by a distance between first side portion 122 and second side portion 124, and a depth 134 defined by a distance between front portion 118 and rear portion 120. Rack system 100 in this embodiment includes a mounting frame 136, formed from four pillars that extend along height 130 of rack system 100. In particular, a first pillar 138 of mounting frame 136 is proximate to front portion 118 of rack system 100 and first side portion 122 of rack system 100. A second pillar 140 of mounting frame 136 is proximate to front portion 118 of rack system 100 and second side portion 124 of rack system 100. First pillar 138 and second pillar 140 are spaced apart by interior width 104 of interior portion 102, and are configured to allow rack-mount equipment 106 to be mounted into rack system 100 at front portion 118 of rack system 100. In this embodiment, first peripheral portion 110 is disposed between first side portion 122 and first pillar 138, and second peripheral portion 112 is disposed between second side portion 124 and second pillar 140.

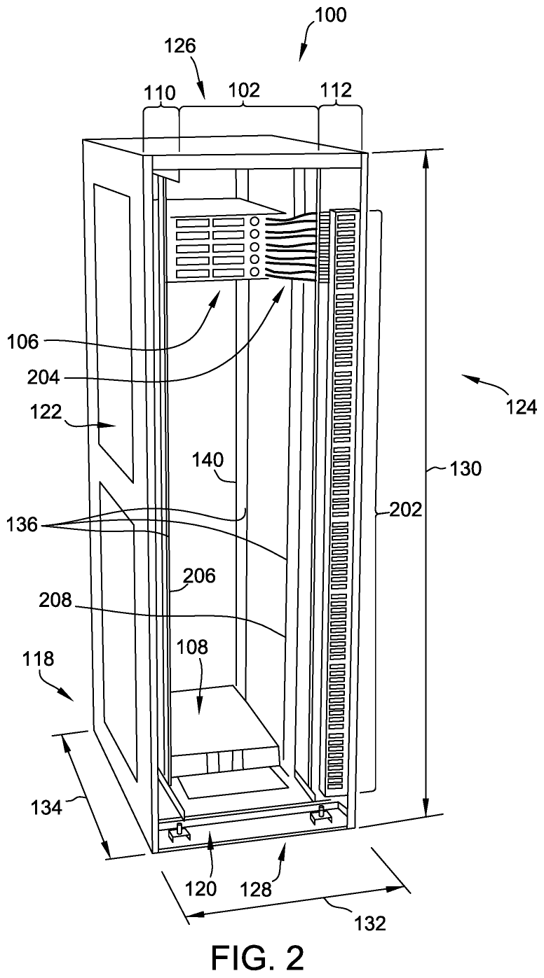

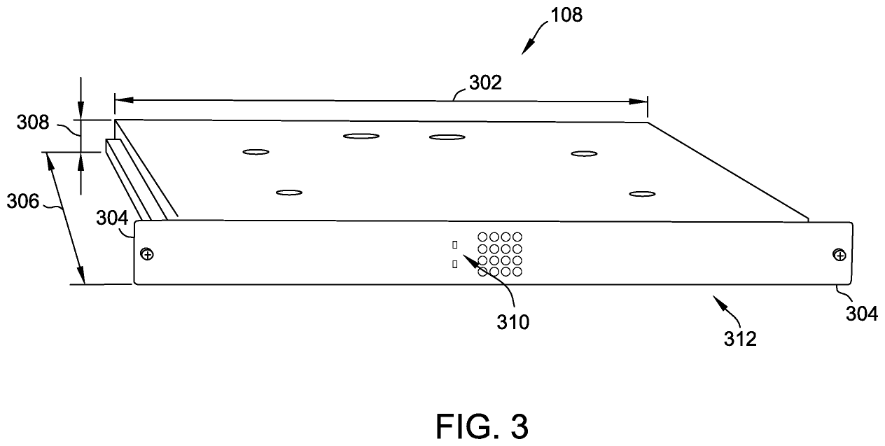

FIG. 2 is a rear perspective view of rack system 100 in an exemplary embodiment. In this view, DC breakers 202 are visible, which extend vertically in rear portion 120 of rack system 100 along height 130 of rack system 100. Power distribution units (not shown) plug into a direct current (DC) bus (not shown) in rear portion 120 of rack system 100. DC breakers 202 distribute DC power from removable battery modules 108 to rack-mount equipment 106 via wires 204. In FIG. 3, a third pillar 206 of mounting frame 136 is proximate to rear portion 120 of rack system 100 and first side portion 122 of rack system 100. A fourth pillar 208 of mounting frame 136 is proximate to rear portion 120 of rack system 100 and second side portion 124 of rack system 100. Third pillar 206 and fourth pillar 208 are spaced apart by interior width 104 of interior portion 102, and are configured to allow rack-mount equipment 106 to be supportably mounted to mounting frame 136 at rear portion 120 of rack system 100. In this embodiment, first peripheral portion 110 is disposed between first side portion 122 and third pillar 206, and second peripheral portion 112 is disposed between second side portion 124 and fourth pillar 208.

FIG. 3 is a front perspective view of removable battery module 108 in an exemplary embodiment. In this embodiment, removable battery module 108 has a battery module width 302, that is similar to interior width 104 of interior portion 102 of rack system 100, with a difference between battery module width 302 and interior width 104 to allow for mounting hardware (e.g., rails). Removable battery module 108 in this embodiment includes front tabs 304 that are used to secure removable battery module 108 to mounting frame 136 (e.g., at first pillar 138 and second pillar 140). Removable battery module 108 has a depth 306 and a height 308 (e.g., 1U) that may vary in other embodiments.

In this embodiment, removable battery module 108 includes light emitting diodes (LEDs) 310 at a front portion 312 of removable battery module 108. LEDs 310 provide a visual status indicator for removable battery module 108, which will be discussed in more detail below.

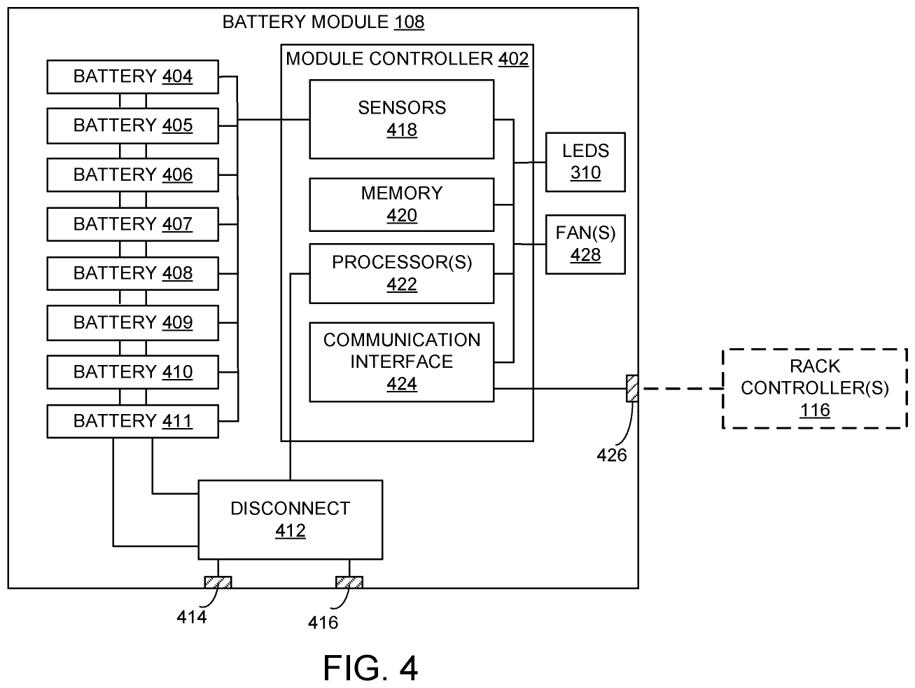

FIG. 4 is a block diagram of removable battery module 108 in an exemplary embodiment. Removable battery module 108 comprises any component, system, or device that performs the functionality described herein for removable battery modules 108 of rack system 100. Removable battery module 108 will be described with respect to various discrete elements, which perform functions. These elements may be combined in different embodiments or segmented into different discrete elements in other embodiments.

In this embodiment, removable battery module 108 comprises a module controller 402, which monitors and controls the charge/discharge operations for batteries 404-411 of removable battery module 108. Although only eight of batteries 404-411 are shown in FIG. 4, removable battery module 108 may include a different number of batteries 404-411 in other embodiments. Further, batteries 404-411 may be wired in series, in parallel, or in series-parallel configurations in other embodiments.

Batteries 404-411 may comprise different battery technologies, including lead acid, lithium ion, lithium iron phosphate, etc. In this embodiment, batteries 404-411 are selectively coupled to the DC bus of rack system 100 via a disconnect 412 and DC bus contacts 414, 416. Disconnect 412 may include a solid-state circuit breaker, an electro-mechanical circuit breaker, or combinations thereof. In some embodiments, disconnect 412 may include multiple disconnects 412, each in series with a battery string, with the battery strings wired in parallel with each other. In this embodiment, module controller 402 comprises one or more sensors 418, memory 420, one or more processors 422, and a communication interface 424.

Sensors 418 are used to monitor the current status of batteries 404-411. Sensors 418 may monitor various conditions of batteries 404-411, including a charge current for batteries 404-411, a discharge current for batteries 404-411, a temperature of batteries 404-411, a voltage of batteries 404-411, a voltage across each of batteries 404-411, an inlet temperature for removable battery module 108, an outlet temperature for removable battery module 108, etc. Memory 420 may store, for example, programmed instructions which are executed by processor 422 to perform the functions described herein for module controller 402. Communication interface 424 provides communications between module controller 402 of removable battery module 108 and rack controllers 116 of rack system 100, via a network connector 426. Communication interface 424 may communicate with rack controllers 116 using any number of different communication networks and/or protocols, including RS-485 or other types of wired or wireless interfaces. In some embodiments, removable battery module 108 includes one or more fans 428, which provide cooling to removable battery module 108.

During operation of removable battery module 108, processor 422 monitors the status of batteries 404-411 via sensors 418, and provides information to rack controllers 116 via communication interface 424 and/or to a user via LEDs 310. Some of the types of information that may be provided by processor 422 to rack controllers 116 and/or to a user via LEDs 310 include, a charge current for batteries 404-411, a discharge current for batteries 404-411, a temperature of batteries 404-411, a voltage of batteries 404-411, a voltage across each of batteries 404-411, an inlet temperature for removable battery module 108, an outlet temperature for removable battery module 108, an average capacity of batteries 404-411, a balance or imbalance state for batteries 404-411, a status of disconnect 412, a cycle count for batteries 404-411, a SOC for batteries 404-411, etc.

If processor 422 detects or calculates various abnormal conditions, processor 422 may provide this information to rack controllers 116 via communication interface 424 and/or to a user via LEDs 310. Such abnormal conditions may include a voltage imbalance at batteries 404-411, an over temperature condition at removable battery module 108, an over current condition at removable battery module 108, a life exceeded at removable battery module 108, a discharge cycle limit exceeded at removable battery module 108, a low voltage at batteries 404-411, a low string voltage at batteries 404-411, a high voltage at one or more of batteries 404-411, a high string voltage at batteries 404-411, a communication failure (e.g., via LEDs 310), etc. During abnormal conditions, processor 422 may electrically disconnect batteries 404-411 from the DC bus of rack system 100 by opening disconnect 412.

During a discharge event, when removable battery module 108 is providing power backup to rack-mount equipment 106 in rack system 100, processor 422 monitors the SOC of batteries 404-406 and reports the SOC information to rack controllers 116 (e.g., processor 422 calculates an average SOC for batteries 404-411, and reports the average SOC for removable battery module 108 to rack controllers 116) and/or to a user via LEDs 310. Generally, the rate of discharge during a high-rate discharge event may be such that batteries 404-411 provide electrical power for up to only a few minutes (e.g., thirty seconds or less) before a backup generator (not shown) starts and provides backup AC power to rack system 100. During high-rate discharge events, processor 422 calculates the SOC of batteries 404-411 and provides information regarding the SOC to rack controllers 116 and/or to a user via LEDs 310. For example, processor 422 may calculate and provide an average SOC of batteries 404-411 to rack controllers 116 and/or to a user via LEDs 310.

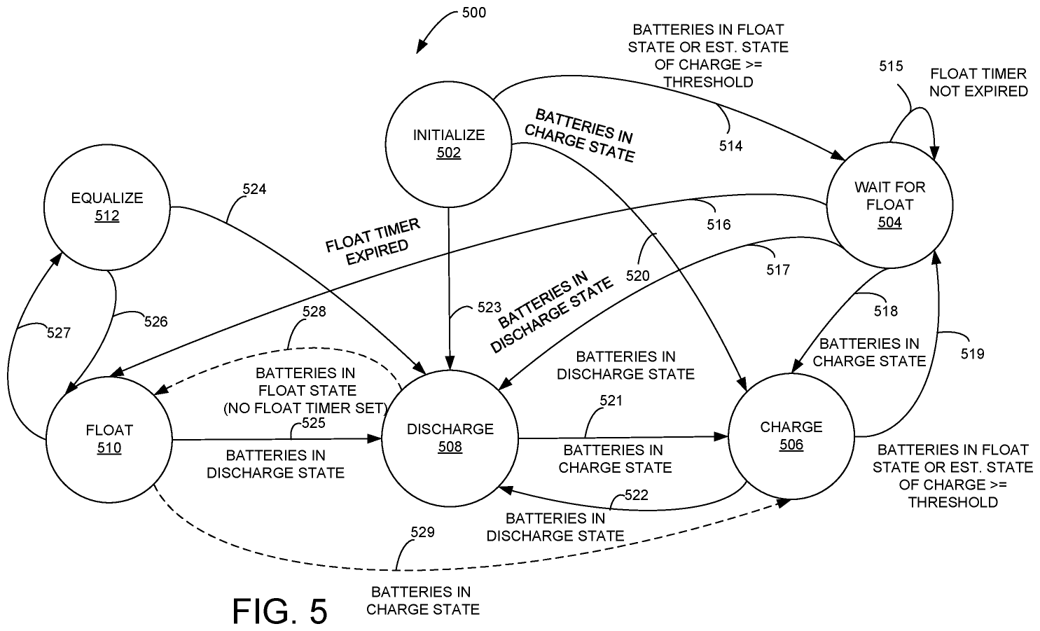

FIG. 5 depicts a SOC state machine 500 for batteries 404-411 of removable battery modules 108 in an exemplary embodiment. State machine 500 begins at an initialize state 502. In initialize state 502, processor 422 estimates a starting SOC for batteries 404-411. If batteries 404-411 are in a float state 510 or the estimated SOC is greater than or equal to a threshold SOC, then processor 422 starts a twelve-hour float timer and transitions state machine 500 to a wait for float state 502. In some embodiments, the threshold SOC is about eighty percent, about eighty five percent, about ninety percent, about ninety five percent, or some other suitable or configurable value.

In some embodiments, the estimated SOC is calculated using the linear slope of the voltage of batteries 404-411 and the temperature of batteries 404-411. Generally, the estimated SOC for a six-volt valve regulated lead acid battery may be calculated by the equations below:

$$SOC \% = ( X 1 + ( X 2 - X 1 ) \times ( Y - ( Y 1 + YN ) ) / ( Y 2 - Y 1 ) ; \\ \qquad eq . 1$$

$$and$$

$$YN = ( YN + ( TM - 20 ) \times ( - \text{.009} ) ) , \qquad eq . 2$$

where X1=“20%”; X2=“100%”, Y=battery voltage, TM is the battery temperature, “−0.009” is three cells at “−3” millivolt/cell, and YN is the measured open circuit voltage of a battery. The millivolt/cell term can be tailored to a specific battery module and manufacturer.

Referring again to FIG. 5, state machine 500 includes a charge state 506, a discharge state 508, a float state 510, and an equalize state 512. In the wait for float state 504, processor 422 increases the estimated SOC of batteries 404-411 incrementally over the remaining float timer, and reports the estimated SOC to rack controllers 116, via communication interface 424 and/or to a user via LEDs 310.

In the charge state 506, processor 422 increases the estimated SOC of batteries 404-411 based on the charge current. Processor 422 may derate the change in the estimated SOC based on the charge efficiency of batteries 404-411. For example, processor 422 may increment the estimated SOC of batteries 404-411 using about eighty percent of the charge current for some valve regulated lead acid batteries. In the charge state 506, processor 422 may start a charge timer. If the batteries 404-411 are in float state 510 or if the estimated SOC of batteries 404-411 is greater than or equal to a threshold SOC, processor 422 starts a timer equal to about twelve hours minus the charge timer in order to determine the remaining time until batteries 404-411 are fully charged.

In discharge state 508, processor 422 decreases the estimated SOC of batteries 404-411 based on the discharge current of batteries 404-411. In float state 510, processor 422 sets the estimated SOC of batteries 404-411 to one hundred percent. State machine 500 translates from wait for float state 504 to float state 510 when the twelve-hour float timer has expired.

In equalize state 512, batteries 404-411 are subjected to an equalization charge, which may be used to charge balance batteries 404-411.

State machine 500 in this embodiment includes state transitions 514-527 that occur between the previously described states. State transitions 518, 520, 521 occur when batteries 404-411 transition to charge state 506. State transitions 517, 522, 523, 524, 525 occur when batteries 404-411 transition to discharge state 508. State transitions 516, 526 occur when batteries 404-411 transition to float state 510. State transitions 514, 515, 519 occur when batteries 404-411 transition or stay in wait for float state 504. Transition 527 occurs when batteries 404-411 transition into equalize state 512. State transitions 514, 519 occur if batteries 404-411 are in float state 510 or the estimated SOC of batteries 404-411 is greater than or equal to a threshold (e.g., about eighty percent). State transition 516 occurs when the float timer expires.

State machine 500 further illustrates state transitions 528, 529 that typically would not occur. State transition 528 could arise if batteries 404-411 are in float state 510 but no float timer has been set. State transition 529 could occur if batteries 404-411 transition from float state 510 to charge state 506.

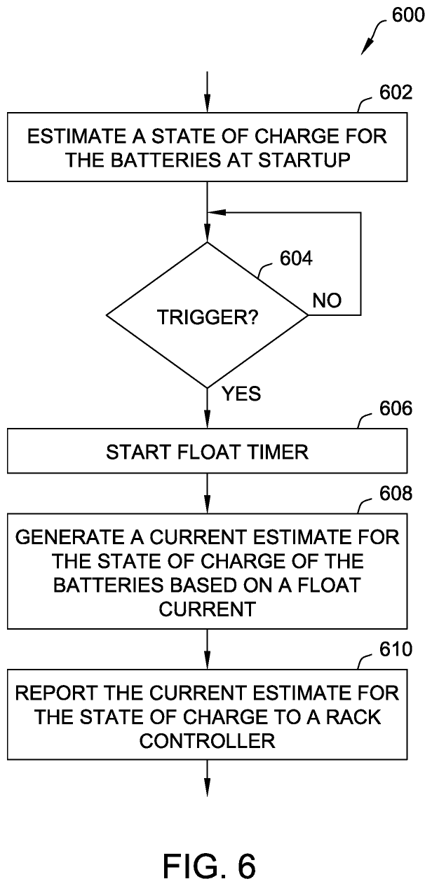

FIG. 6 is a flow chart of a method 600 operable by a removable battery module for a rack system that includes at least one rack controller in an exemplary embodiment. Method 600 may be performed by removable battery module 108 of rack system 100 or other systems, not shown or described.

Method 600 begins by estimating 602 a SOC of at least one battery of the removable battery module at startup. For example, processor 422 estimates a SOC of batteries 404-411 in response to removable battery module 108 being installed in rack system 100 (see FIGS. 1 and 3), in initialize state 502 (see FIG. 5).

Method 600 continues by determining 604 whether at least one trigger has occurred. For example, one trigger may be that batteries 404-411 are in float state 510. Another trigger may be that the estimated SOC of batteries 404-411 is greater than or equal to a threshold SOC (e.g., about eighty percent). If at least one trigger has occurred, then method 600 continues by starting 606 a float timer. For example, processor 422 starts a twelve-hour float timer and transitions from initialize state 502 to wait for float state 504, via state transition 514 (see FIG. 5).

Method 600 continues by generating 608 a current estimate for the SOC of the at least one battery by increasing the estimated SOC over a remaining time of the float timer based on a float current. For example, processor 422 increases the estimated SOC over the twelve-hour float timer based on the float current supplied to batteries 404-411, in wait for float state 504.

Method 600 continues by reporting 610 the current estimate for the SOC of the at least one battery to the at least one rack controller. For example, processor 422 reports the current estimate to one or more of rack controllers 116, via communication interface 424.

In an optional embodiment, method 600 includes determining that the float timer has expired, and sets the current estimate for the SOC of the at least one battery to one hundred percent. For example, processor 422 determines that the twelve-hour float timer has expired, and transitions from wait for float state 504 to float state 510 via state transition 516 (see FIG. 5), and processor 422 sets the estimated SOC for batteries 404-411 to one hundred percent.

In another optional embodiment, method 600 includes determining whether the at least one battery is discharging, measuring, in response to determining that the at least one battery is discharging, a discharge current, and decreasing, based on the discharge current, the current estimate for the SOC of the at least one battery while the at least one battery is discharging. For example, processor 422 transitions state machine 500 into discharge state 508 via state transitions 517, 522, 523, 524, 525, measures the discharge current via sensors 418, and decreases the current estimate for the SOC of batteries 404-411 while batteries 404-411 are in discharge state 508.

In another optional embodiment, method 600 includes determining whether the at least one battery is charging, measuring, in response to determining that the at least one battery is charging, a charge current, and increasing, based on the charge current, the current estimate for the SOC of the at least one battery while the at least one battery is charging. For example, processor 422 transitions state machine 500 into charge state 506 via state transitions 518, 520, 521, measures the charge current via sensors 418, and increases the current estimate for the SOC of batteries 404-411 while batteries 404-411 are in charge state 506.

An example technical effect of the embodiments described herein includes at least one of: (a) improving the accuracy of SOC estimates for battery modules in high-rate discharge applications; (b) ensuring that the batteries of removable battery modules are initially charged at startup; (c) improved speed of information and completeness at rack controllers 116 for user and remote access; and (d) the SOC information is now part of removable battery modules 108, and remains within removable battery modules 108 when removable battery modules 108 are moved within rack system 100 or installed into a different rack system 100.

Although specific features of various embodiments of the disclosure may be shown in some drawings and not in others, this is for convenience only. In accordance with the principles of the disclosure, any feature of a drawing may be referenced and/or claimed in combination with any feature of any other drawing.

This written description uses examples to disclose the embodiments, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A removable battery module for a rack system, the rack system including at least one rack controller, the removable battery module comprising:
at least one battery;
a communication interface configured to communicatively couple with the at least one rack controller; and
a module controller configured to:
estimate a state of charge (SOC) of the at least one battery at startup;
determine whether at least one trigger has occurred;
start a float timer in response to determining that the at least one trigger has occurred;
generate a current estimate for the SOC of the at least one battery by increasing the estimated SOC over a remaining time of the float timer based on a float current; and
report, via the communication interface, the current estimate for the SOC of the at least one battery to the at least one rack controller.

2. The removable battery module of claim 1, wherein the module controller is further configured to:
determine that the float timer has expired; and
set the current estimate for the SOC of the at least one battery to 100%.

3. The removable battery module of claim 2, wherein the module controller is further configured to:
perform an equalization charge on the at least one battery in response to determining that the float timer has expired.

4. The removable battery module of claim 1, wherein the module controller is further configured to:
determine whether the at least one battery is discharging;
measure, in response to determining that the at least one battery is discharging, a discharge current; and
decrease, based on the discharge current, the current estimate for the SOC of the at least one battery while the at least one battery is discharging.

5. The removable battery module of claim 1, wherein the module controller is further configured to:
determine whether the at least one battery is charging;
measure, in response to determining that the at least one battery charging, a charge current; and
increase, based on the charge current, the estimated SOC of the at least one battery while the at least one battery is charging.

6. The removable battery module of claim 1, wherein the at least one trigger comprises at least one of:
the estimated SOC is greater than a threshold SOC; and
the at least one battery is in a float charge.

7. The removable battery module of claim 6, wherein the threshold SOC is greater than or equal to 80%.

8. A method operable by a removable battery module for a rack system, the rack system including at least one rack controller, the method comprising:
estimating a state of charge (SOC) of at least one battery of the removable battery module at startup;
determining whether at least one trigger has occurred;
starting a float timer in response to determining that the at least one trigger has occurred;
generating a current estimate for the SOC of the at least one battery by increasing the estimated SOC over a remaining time of the float timer based on a float current; and
reporting the current estimate for the SOC of the at least one battery to the at least one rack controller.

9. The method of claim 8, further comprising:
determining that the float timer has expired; and
setting the current estimate for the SOC of the at least one battery to 100%.

10. The method of claim 9, further comprising:
performing an equalization charge on the at least one battery in response to determining that the float timer has expired.

11. The method of claim 8, further comprising:
determining whether the at least one battery is discharging;
measuring, in response to determining that the at least one battery is discharging, a discharge current; and
decreasing, based on the discharge current, the current estimate for the SOC of the at least one battery while the at least one battery is discharging.

12. The method of claim 8, further comprising:
determining whether the at least one battery is charging;
measuring, in response to determining that the at least one battery is charging, a charge current; and
increasing, based on the charge current, the estimated SOC of the at least one battery while the at least one battery is charging.

13. The method of claim 8, wherein the at least one trigger comprises at least one of:
the estimated SOC is greater than a threshold SOC; and
the at least one battery is in a float charge.

14. The method of claim 13, wherein the threshold SOC is greater than or equal to 80%.

15. A rack system, comprising:
a mounting frame configured to mount rack-mount equipment within an interior portion of the rack system, the mounting frame extending along at least a portion of a height of the rack system;
at least one rack controller disposed within a peripheral portion of the rack system, the peripheral portion disposed external to the interior portion and extending along at least a portion of the mounting frame; and
at least one removable battery module disposed within the peripheral portion, each removable battery module comprising:
at least one battery;
a communication interface configured to communicatively couple with the at least one rack controller; and
a module controller configured to:
estimate a state of charge (SOC) of the at least one battery at startup;
determine whether at least one trigger has occurred;
start a float timer in response to determining that the at least one trigger has occurred;
generate a current estimate for the SOC of the at least one battery by increasing the estimated SOC over a remaining time of the float timer based on a float current; and
report, via the communication interface, the current estimate for the SOC of the at least one battery to the at least one rack controller.

16. The rack system of claim 15, wherein the module controller is further configured to:
determine that the float timer has expired; and
set the current estimate for the SOC of the at least one battery to 100%.

17. The rack system of claim 16, wherein the module controller is further configured to:
perform an equalization charge on the at least one battery in response to determining that the float timer has expired.

18. The rack system of claim 15, wherein the module controller is further configured to:
determine whether the at least one battery is discharging;
measure, in response to determining that the at least one battery is discharging, a discharge current; and
decrease, based on the discharge current, the current estimate for the SOC of the at least one battery while the at least one battery is discharging.

19. The rack system of claim 15, wherein the module controller is further configured to:
determine whether the at least one battery is charging;
measure, in response to determining that the at least one battery charging, a charge current; and
increase, based on the charge current, the estimated SOC of the at least one battery while the at least one battery is charging.

20. The rack system of claim 15, wherein the at least one trigger comprises at least one of:
the estimated SOC is greater than a threshold SOC; and
the at least one battery is in a float charge.
